(19) United States
(12) Patent Application Publication
(10) Pub. No.: US 2018/0032322 A1
(43) Pub. Date: Feb. 1, 2018

(54) AUTOMATED DEVOPS APPLICATION DEPLOYMENT

(71) Applicant: HEWLETT PACKARD ENTERPRISE DEVELOPMENT LP, Houston, TX (US)

(72) Inventors: Kishore Jagannath, Bangalore (IN); Namitha R. Prabhu, Bangalore (IN); Vineet Raj, Bangalore (IN)

(21) Appl. No.: 15/223,226

(22) Filed: Jul. 29, 2016

(51) Int. Cl. G06F 9/445; G06F 21/62; G06F 9/44

(52) U.S. Cl. CPC G06F 8/60; G06F 8/77; G06F 21/6218

(57) ABSTRACT

Examples disclosed herein relate to automated development operations (DevOps) application deployment. Some examples disclosed herein may include generating a DevOps application deployment packages for DevOps applications based on DevOps application models for deploying the DevOps applications. Application deployment tools for deploying the DevOps applications may be determined based on the DevOps application deployment packages. The DevOps application deployment packages may be provided deployment tool plugins associated with the determined application deployment tools and the deployment tool plugins may execute deployment operations based on deployment properties included in the DevOps application deployment packages to deploy DevOps applications using the determined application deployment tools.

### BACKGROUND

Development operations (or DevOps) allows enterprises to quickly design, build, test, deploy, and maintain software applications. DevOps accomplishes this by facilitating continuous deployment and release pipeline management, resulting in faster release lifecycles without compromising application quality.

### BRIEF DESCRIPTION OF THE DRAWINGS

The following detailed description references the drawings, wherein:

FIG. 1 is a block diagram of an example system for automated DevOps application deployment;

FIG. 2 is an illustration of an example DevOps application deployment package for automated DevOps application deployment;

FIG. 3 is a flowchart of an example method for automated DevOps application deployment;

FIG. 4 is a block diagram of an example machine-readable medium for automated DevOps application deployment; and

FIG. 5 is a block diagram of an example system for automated DevOps application deployment.

### DETAILED DESCRIPTION

The following detailed description refers to the accompanying drawings. Wherever possible, the same reference numbers are used in the drawings and the following description to refer to the same or similar parts. It is to be expressly understood, however, that the drawings are for the purpose of illustration and description only. Mile several examples are described in this document, modifications, adaptations, and other implementations are possible. Accordingly, the following detailed description does not limit the disclosed examples. Instead, the proper scope of the disclosed examples may be defined by the appended claims.

The terminology used herein is for the purpose of describing particular examples only and is not intended to be limiting. As used herein, the singular forms “a,” “an,” and “the” are intended to include the plural forms as well, unless the context clearly indicates otherwise. The term “plurality,” as used herein, is defined as two or more than two. The term “another,” as used herein, is defined as at least a second or more. The term “coupled,” as used herein, is defined as connected, whether directly without any intervening elements or indirectly with at least one intervening elements, unless otherwise indicated. Two elements can be coupled mechanically, electrically, or communicatively linked through a communication channel, pathway, network, or system. The term “and/or” as used herein refers to and encompasses any and all possible combinations of the associated listed items. It will also be understood that, although the terms first, second, third, etc. may be used herein to describe various elements, these elements should not be limited by these terms, as these terms are only used to distinguish one element from another unless stated otherwise or the context indicates otherwise. As used herein, the term “includes” means includes but not limited to, the term “including” means including but not limited to. The term “based on” means based at least in part on.

DevOps solutions allow enterprises to quickly design, build, test, deploy, and maintain software applications. DevOps solutions accomplish this by facilitating continuous deployment and release pipeline management, resulting in faster release lifecycles without compromising application quality. Example functionalities of DevOps solutions include pipeline management, release gates, continuous application deployment, and integration with integrated development environments (IDEs).

The functionality of a DevOps solution may rely on an application deployment tool underneath, which facilitates automation of the application deployment process. In some examples, the functionalities of a DevOps solution may be tightly coupled to the underlying application deployment tool. However, the same application deployment tool may not be suitable for different application deployments. For example, different enterprises may have different preferences for modelling their application deployment. Moreover, requirements for application deployment tool may differ based on the structure and complexity of applications to be deployed.

Examples disclosed herein describe technical solutions to these technical challenges by providing systems, methods, and computer-readable media for automated DevOps application deployment. In the disclosed examples, the functionalities of a DevOps solution may be decoupled from the underlying application deployment tool and packaged as a microservice. The DevOps microservice may be plugged in to any DevOps lifecycle stage and adapted to any application deployment tool, thereby providing enterprises with the flexibility to use different application deployment tools for different DevOps application deployments.

In some examples, DevOps application deployment packages may be generated for DevOps applications based on DevOps application models for deploying the DevOps applications. Application deployment tools for deploying the DevOps applications may be determined based on the DevOps application deployment packages. The DevOps application deployment packages may be provided deployment tool plugins associated with the determined application deployment tools and the deployment tool plugins may execute deployment operations based on deployment properties included in the DevOps application deployment packages to deploy DevOps applications using the determined application deployment tools.

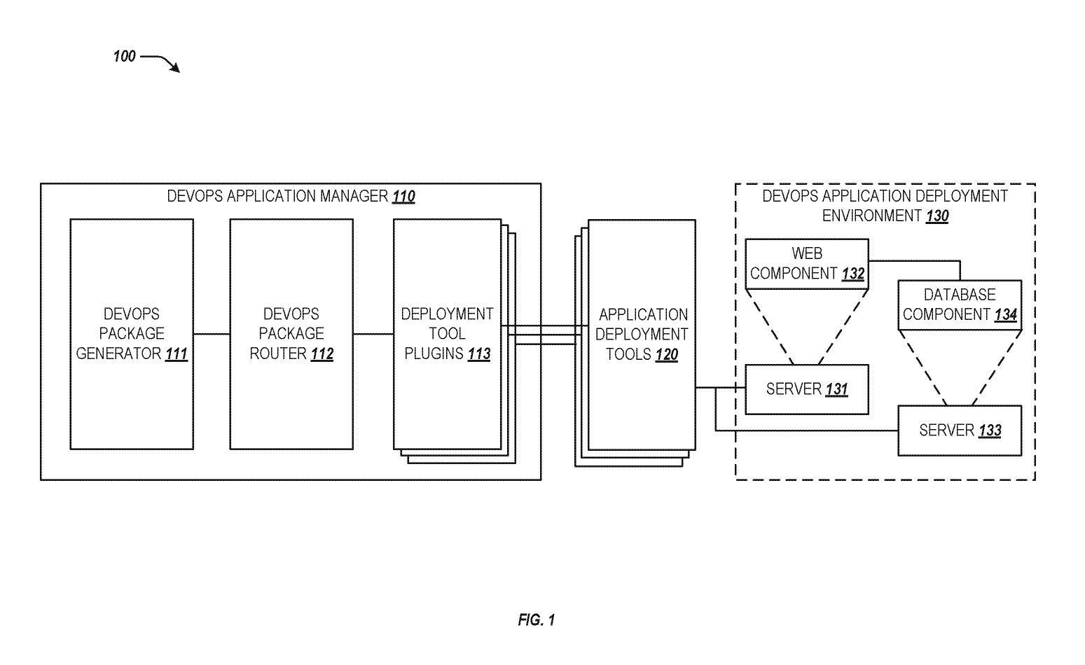

FIG. 1 is a block diagram of an example computing system 100 for automated DevOps application deployment. Computing system 100 may be implemented by a single computing system or a plurality of computing systems. A computing system, as used herein, may be any type of computing system including, but not being limited to: a laptop, a desktop, an all-in-one device, a thin client, a workstation, a tablet computer, a mobile device, a network-enabled appliance (e.g., a “Smart” television), an Internet of Things (IoT) sensor, a server device, and a storage device.

As shown in FIG. 1, computing system 100 may include a number of components such as a DevOps application manager 110, a plurality of application deployment tools 120, and a DevOps application deployment environment 130. The number and arrangement of these components is an example only and provided for purposes of illustration. Other arrangements and numbers of components may be utilized without departing from the examples of the present disclosure.

DevOps application manager 110 may be implemented as a standalone computing system or computing systems, or may be implemented as a combination of electronic circuitry (i.e., hardware) and software/firmware included in computing system 100 that implements the functionality of DevOps application manager 110. For example, DevOps application manager 110 may be implemented partially or fully in a central processing unit (CPU), in a dedicated integrated circuit such as an ASIC (application-specific integrated circuit), or in a dedicated FPGA (field-programmable gate array) of computing system 100 that executes instructions (e.g., stored on a machine-readable storage medium of computing system 100) to offer the functionality of DevOps application manager 110.

DevOps application manager 110 may manage the lifecycle of DevOps applications. A DevOps application may be an application that is designed to be deployed through various DevOps lifecycle stages. The DevOps toolchain is designed to promote collaboration, integration, and communication between development, operations, and testing/quality assurance teams. The DevOps toolchain may include a series of lifecycle stages that aid in the development, deployment, and management of an application through the application's lifecycle. DevOps lifecycle stages may include development, testing, staging, and production. Each DevOps lifecycle stage may have an associated set of users, user privileges, tasks, DevOps policies, and environments relevant for that stage.

A development DevOps lifecycle stage may include designing an application and coding software builds for the application. Each software build may be tested for quality and performance to identify potential release candidate builds for the application. Users for the development stage may include developers. A set of privileges may be specified for the developers in the development stage. For example, developers may be given a wide range of privileges to freely develop and modify applications in development. An example of a development stage deployment environment may include a private or local computing system (such as a developer's desktop, workstation, or server), a local virtual machine, or a private cloud.

A testing DevOps lifecycle stage may include various types of application testing. Example application tests include acceptance testing, regression testing, and configuration testing. Moreover, a testing stage may include analysis of performance and security of the application. Users for the testing stage may include testers. User privileges for the testing stage may allow testers to run tests on an application under test while limiting (or prevent) developers' abilities to make changes to an application while under test. User privileges may further specify an approver whom is given authority to promote applications under test to staging or production.

A staging DevOps lifecycle stage may include final testing of an application prior to the application's deployment into production. The application may be tested during staging by a set of users similar to those whom will use the application in production and whom are given a set of user privileges similar to those used in production. The application may be deployed in staging in an environment closely emulating the production environment.

A production DevOps lifecycle stage may include packaging an application for production and releasing the packaged application into production. Releasing an application into production may include deploying an application into a production environment. An example of a production environment may include a public cloud, a data center, a publicly accessible server, and a public virtual machine.

DevOps application manager 110 may use various application deployment tools 120 to deploy DevOps applications onto DevOps application deployment environment 130. Application deployment tools 120 may include continuous integration configuration management tools such as HP Codar, Chef™, Puppet, Ubuntu Juju, shell scripts, and Apache® Mesos. Application deployment tools 120 may be implemented as a combination of hardware and software/firmware as described above regarding DevOps application manager 110 generally.

Using application deployment tools 120 to deploy DevOps applications may include using application deployment tools 120 to configure DevOps application deployment environment 130 for DevOps application deployment. Application deployment tools 120 may configure DevOps application deployment environment 130 by configuring various servers or other computing systems (e.g., cloud computing systems, local computing systems, virtual machines, etc.) of DevOps application deployment environment 130 to host and run components of DevOps applications. For example, application deployment tools 120 may configure server 131 to host and run web component 132 and may configure server 133 to host and run database component 134. Web component 132 may include the web application of a deployed DevOps application used by users whereas database component 134 may include the build libraries of the deployed DevOps application, user data, log files, etc.

The combination of components 131-134 included in DevOps application deployment environment 130 shown in FIG. 1 is an example only and other components and configurations of components may be used. Each of components 131-134 may be implemented as a combination of hardware and software/firmware as described above regarding DevOps application manager 110 generally, and may be selected based upon the DevOps lifecycle stage in which the DevOps application is being deployed. For example, DevOps application deployment environment 130 may be a private cloud environment for a development DevOps lifecycle stage and servers 131, 133 may include private cloud servers. As another example, DevOps application deployment environment 130 may be a public cloud environment or data center for a production DevOps lifecycle stage, and servers 131, 133 may include public cloud servers or date center rack-mounted servers.

DevOps application manager 110 may receive DevOps application models for deploying DevOps applications. A DevOps application model may include a topology of components included in a DevOps application and a set of requirements for implementing the component topology in DevOps application deployment environment 130. For example, a DevOps application model may include a web component 132 and a database component 134 of a DevOps application. The requirements included in a DevOps application may specify on which servers or other computing systems the components are to be deployed (e.g., servers 131, 133) how and when they are to be deployed, etc. Developers may model DevOps applications using application modeling software such as HP Codar. In some examples, DevOps application models may be received from users (via an I/O device(s) such as a keyboard, mouse, and/or touchscreen; a network; a communications interface, etc.), from other components of computing system 100 (e.g., other servers, databases, etc.) or from components of other computing systems external to computing system 100.

DevOps application manager 110 may include a DevOps package generator 111, a DevOps package router 112, and a plurality of deployment tool plugins 113. DevOps package generator 111, DevOps package router 112, and deployment tool plugins 113 may be implemented as a combination of hardware and software/firmware as described above regarding DevOps application manager 110 generally.

DevOps package generator 111 may generate DevOps application deployment packages for DevOps applications. DevOps application deployment packages may be generated based on DevOps application models for deploying the DevOps applications. Generated DevOps application deployment packages may be used as microservices that allow DevOps applications to be plugged into any application deployment tool without (or with very little) modification.

To allow DevOps application packages to be plugged into different application deployment tools, DevOps package generator 111 may include a set of properties in generated DevOps application packages for deploying associated DevOps applications in DevOps application deployment environment 130. The deployment properties may be used by deployment tool plugins 113 to configure DevOps application deployment environment 130 using any of application deployment tools 120.

In some examples, the deployment properties included in a DevOps application deployment package may be properties that are modifiable by users/developers. In some examples, the deployment properties included in a DevOps application deployment package may be properties that change between each DevOps application deployment or change frequently between DevOps application deployments (e.g., every other deployment, every third deployment, etc.). Examples of deployment properties that may be included in a DevOps application deployment package include an identification of a web component file for a DevOps application build (e.g., a .WAR file or .EAR file), a location of the web component file, a port on which the web component listens, identification and address of the server on which the web component is to be deployed, a time at which the web component is to be deployed, an identification and location of a database component file for the DevOps application, a username and password for the database component, identification and address of the server on which the database component is to be deployed, a time at which the web component is to be deployed, a log file location for the DevOps application build, the DevOps lifecycle stage in which the DevOps application is to be deployed, DevOps lifecycle stage user/developer privileges, DevOps lifecycle stage approvers, acceptance criteria for the DevOps application in the particular DevOps lifecycle stage, etc.

DevOps application deployment packages may be generated based on DevOps application models in that the properties included in a deployment package may be based on the component topology and implementation requirements specified in a DevOps application model. For example, a component topology in a DevOps application model may specify a build of a DevOps application and a server on which the build is to be deployed. DevOps package generator 111 may generate a DevOps application deployment package for the DevOps application that includes properties such as a .WAR file associated with the web component of the build, a location of the .WAR file, and an address for the server on which the .WAR file is to be deployed.

DevOps package router 112 may determine application deployment tools 120 for deploying DevOps applications in DevOps application deployment environment 130. DevOps package router 112 may automatically determine an application deployment tool among application deployment tools 120 for deploying a DevOps application based on the DevOps application deployment package associated with the DevOps application. For example, DevOps package router 112 may examine a DevOps application deployment package for a DevOps application and determine the application deployment tool specified in the deployment properties included in the DevOps application deployment package.

As another example DevOps package router 112 may examine a DevOps application deployment package for a DevOps application and determine the application deployment tool based on complexity of the DevOps application. For example, less complex DevOps applications may be deployed using less complex application deployment tools (e.g., shell scripts, Chef) whereas more complex DevOps applications may be deployed using more sophisticated application deployment tools such as HP Codar. The complexity of a DevOps application may be based on a number of application components to be deployed for the DevOps application, a number of servers or other computing systems on which application components are to be deployed, etc.

DevOps package router 112 may also automatically determine an application deployment tool among application deployment tools 120 based on the application deployment tools 120 available in computing system 100 and the DevOps application deployment environment 130 in which the DevOps application is to be deployed. In some examples, as an alternative to DevOps package router 112 automatically determining an application deployment tool among application deployment tools 120, developers may specify the application deployment tool among application deployment tools 120 as input to DevOps package router 112.

DevOps package router 112 may provide DevOps application deployment packages to deployment tool plugins 113 associated with application deployment tools 120. For example, DevOps package router 112 may determine a deployment tool plugin among deployment tool plugins 113 associated with a determined application deployment tool among application deployment tools 120 and provide a DevOps application deployment package to the determined deployment tool plugin.

Deployment tool plugins 113 may execute deployment operations to deploy DevOps applications in DevOps application deployment environment 130 using application deployment tools 120. In some examples, deployment operation instructions may be received at DevOps application manager 110 from users (e.g., via an I/O device, a network, a communications interface, etc.). In some examples, deployment operation instructions may be included in a DevOps application deployment package generated for a DevOps application. Deployment operation instructions may include instructions to execute various deployment operations. Examples of deployment operations include deploying a DevOps application (i.e., deploying an application in DevOps application deployment environment 130), undeploying a DevOps application (i.e., removing an application from DevOps application deployment environment 130), and redeploying a DevOps application (i.e., removing an application from DevOps application deployment environment 130 and deploying the application again in DevOps application deployment environment 130). Deployment operation instructions may also specify a DevOps lifecycle stage in which a DevOps application is to be deployed. For example, deployment operation instructions may include instructions to deploy (or undeploy or redeploy) a DevOps application in a development stage, a testing stage, a staging stage, and/or a production stage.

Deployment tool plugins 113 may execute deployment operations based on deployment properties included DevOps application deployment packages. To execute a deployment operation, deployment tool plugins 113 may, based on deployment properties included in DevOps application deployment packages, instruct associated application deployment tools 120 to configure DevOps application deployment environment 130. For example, deployment tool plugins 113 may use associated application deployment tools 120 to configure server 131 with web component 132 of a DevOps application based on the web component 132 deployment properties included in a DevOps application deployment package associated with the DevOps application. As another example, deployment tool plugins 113 may use associated application deployment tools 120 to configure server 133 with database component 134 of a DevOps application based on the database component 134 deployment properties included in a DevOps application deployment package associated with the DevOps application.

Deployment tool plugins 113 may instruct associated application deployment tools 120 to configure DevOps application deployment environment 130 by translating the deployment properties included in a DevOps application deployment package to low-level implementation instructions understandable by application deployment tools 120. As an example, where a DevOps application deployment package specifies the location of a .WAR file of a DevOps application to be deployed as a deployment property, a deployment tool plugin 113 associated with a Chef application deployment tool 120 may provide low-level implementation instructions understandable by the Chef application deployment tool 120 to deploy the specified .WAR file as web component 132 on server 131.

In some examples, DevOps application manager 110 may generate deployment tool plugins 113 for application deployment tools 120. For example, a deployment tool plugin may be generated for each new application deployment tool made available in computing system 100. DevOps application manager 110 may generate deployment tool plugins 113 such that each deployment tool plugin includes the intricacies and low-level implementation details of the associated application deployment tool needed to translate deployment properties to implementation instructions understandable by the associated application deployment tool for deploying DevOps applications using the associated application deployment tool.

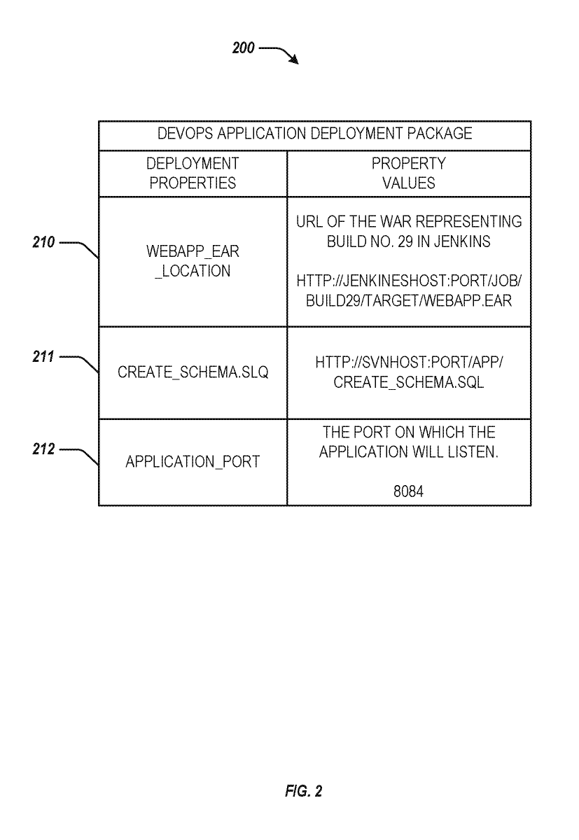

FIG. 2 is an illustration of an example DevOps application deployment package 200 for automated DevOps application deployment. In some examples, DevOps application deployment package 200 may be generated by a DevOps package generator, such as DevOps package generator 111 described above in DevOps application manager 110 of FIG. 1. As shown in FIG. 2, example DevOps application deployment package 200 may include a plurality of deployment properties 210-212. Deployment properties 210-212 are examples only and other/different combinations of Deployment properties may be included in DevOps application deployment packages. Deployment property 210 may specify a location of a .WAR file associated with build number 29 of the DevOps application. Deployment property 211 may specify a database schema for a database component of the DevOps application. Deployment property 212 may specify an application port number on which the web component of the DevOps application listens.

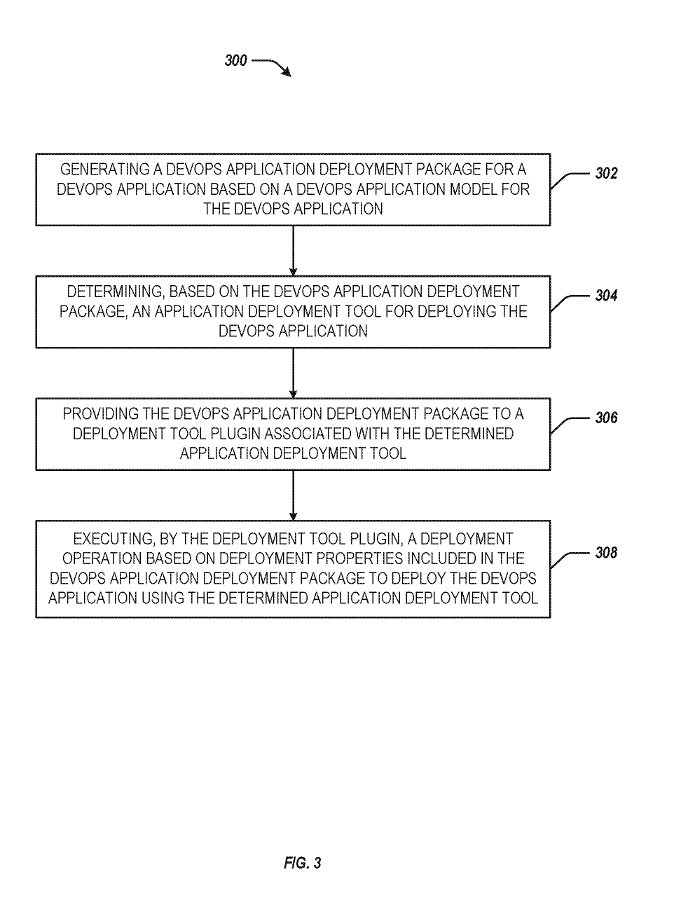

FIG. 3 is a flowchart depicting an example method 300 for automated DevOps application deployment. Method 300 may be executed or performed, for example, by some or all of the system components described above in computing system 100 of FIG. 1. Other suitable computing systems may be used as well. Method 300 may be implemented in the form of executable instructions stored on at least one machine-readable storage medium of the system and executed by at least one processor of the system. Alternatively or in addition, method 300 may be implemented in the form of electronic circuitry (e.g., hardware). In some examples, steps of method 300 may be executed substantially concurrently or in a different order than shown in FIG. 3. In some examples, method 300 may include more or less steps than are shown in FIG. 3. In some examples, some of the steps of method 300 may, at certain times, be ongoing and/or may repeat.

At block 302, method 300 may include generating a DevOps application deployment package for a DevOps application based on a DevOps application model for the DevOps application. Referring back to FIG. 1, DevOps package generator 111 of DevOps application manager 110 may be responsible for implementing block 302.

At block 304, method 300 may include determining, based on the DevOps application deployment package generated at block 302, an application deployment tool for deploying the DevOps application. Referring back to FIG. 1, DevOps package router 112 of DevOps application manager 110 may be responsible for implementing block 304.

At block 306, method 300 may include providing the DevOps application deployment package to a deployment tool plugin associated with the application deployment tool determined at block 304. Referring back to FIG. 1, DevOps package router 112 of DevOps application manager 110 may be responsible for implementing block 306.

At block 308, method 300 may include by the deployment tool plugin, a deployment operation based on deployment properties included in the DevOps application deployment package to deploy the DevOps application using the determined application deployment tool. Referring back to FIG. 1, one of deployment tool plugins 113 of DevOps application manager 110 may be responsible for implementing block 308.

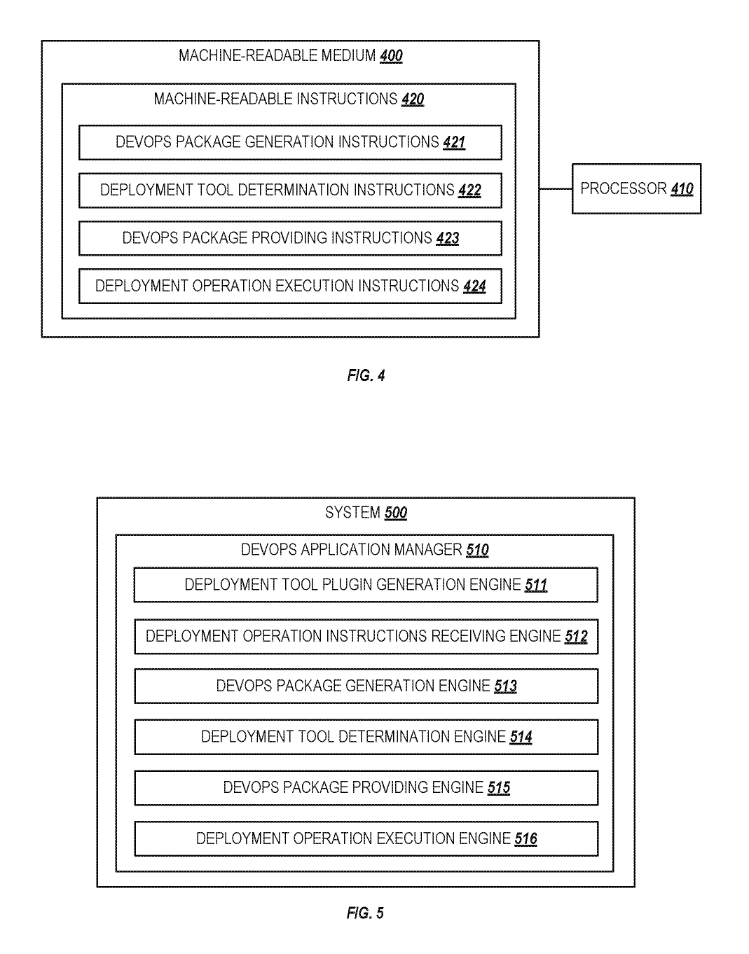

FIG. 4 is a block diagram of an example machine-readable medium 400 for automated DevOps application deployment. Machine-readable medium 400 may be communicatively coupled to a processor 410. Machine-readable medium 400 and processor 410 may, for example, be included as part of computing system 100 illustrated in FIG. 1. Although the following descriptions refer to a single processor and a single machine-readable storage medium, the descriptions may also apply to a system with multiple processors and/or multiple machine-readable storage mediums. In such examples, the instructions may be distributed (e.g., stored) across multiple machine-readable storage mediums and the instructions may be distributed (e.g., executed by) across multiple processors.

Processor 410 may be central processing units (CPUs), microprocessors, and/or other hardware devices suitable for retrieval and execution of instructions stored in machine-readable storage medium 400. In the example shown in FIG. 4, processor 410 may fetch, decode, and execute machine-readable instructions 420 (including instructions 421-424) for automated DevOps application deployment. As an alternative or in addition to retrieving and executing instructions, processor 410 may include electronic circuits comprising a number of electronic components for performing the functionality of the instructions in machine-readable storage medium 400. With respect to the executable instruction representations (e.g., boxes) described and shown herein, it should be understood that part or all of the executable instructions and/or electronic circuits included within one box may, in some examples, be included in a different box shown in the figures or in a different box not shown.

Machine-readable storage medium 400 may be any electronic, magnetic, optical, or other physical storage device that stores executable instructions. Thus, machine-readable storage medium 400 may be, for example, Random Access Memory (RAM), a nonvolatile RAM (NVRAM) (e.g., RRAM, PCRAM, MRAM, etc.), an Electrically-Erasable Programmable Read-Only Memory (EEPROM), a flash memory, a storage drive, an optical disc, and the like. Machine-readable storage medium 400 may be disposed within a computing system (e.g., computing system 100 of FIG. 1). In this situation, the executable instructions may be “installed” on the computing system. Alternatively, machine-readable storage medium 400 may be a portable, external or remote storage medium, for example, that allows a computing system to download the instructions from the portable/external/remote storage medium. In this situation, the executable instructions may be part of an “installation package”. As described herein, machine-readable storage medium 400 may be encoded with executable instructions for automated DevOps application deployment.

Referring to FIG. 4, DevOps package generation instructions 421, when executed by a processor (e.g., 410), may cause the processor to generate a development operations (DevOps) application deployment package for a DevOps application based on a DevOps application model for deploying the DevOps application. Deployment tool determination instructions 422, when executed by a processor (e.g., 410), may cause the processor to determine, based on the DevOps application deployment package, an application deployment tool for deploying the DevOps application among a plurality of application deployment tools. DevOps package providing instructions 423, when executed by a processor (e.g., 410), may cause the processor to provide the DevOps application deployment package to a deployment tool plugin associated with the determined application deployment tool. Deployment operation execution instructions 424, when executed by a processor (e.g., 410), may cause the processor to execute, by the deployment tool plugin, a deployment operation based on deployment properties included in the DevOps application deployment package to deploy the DevOps application on the determined application deployment tool in a DevOps lifecycle stage. The deployment properties may include at least a location of a web component file for the DevOps application.

FIG. 5 is a block diagram depicting an example system 500, including a DevOps application manager 510, for automated DevOps application deployment, DevOps application manager 510 may include a deployment tool plugin generation engine 511, a deployment operation instructions receiving engine 512, a DevOps package generation engine 513, a deployment tool determination engine 514, a DevOps package providing engine 515, and a deployment operation execution engine 516. In some examples, DevOps application manager 510 may be implemented by DevOps application manager 110 of FIG. 1.

The term “engine”, as used herein in reference to components 511-516, refers to a combination of hardware and programming that performs a designated function. For example, the hardware of each engine may include one or both of a processor and a machine-readable storage medium, while the programming is instructions or code stored on the machine-readable storage medium and executable by the processor to perform the designated function.

Referring to FIG. 5, deployment tool plugin generation engine 511 may include a processor and program instructions that, when executed, cause the processor to generate a plurality of deployment tool plugins for a plurality of application deployment tools. Deployment operation instructions receiving engine 512 may include a processor and program instructions that, when executed, cause the processor to receive deployment operation instructions for deploying a DevOps application. DevOps package generation engine 513 may include a processor and program instructions that, when executed, cause the processor to generate a DevOps application deployment package for the DevOps application based on a DevOps application model for deploying the DevOps application. Deployment tool determination engine 514 may include a processor and program instructions that, when executed, cause the processor to determine, based on the DevOps application deployment package, an application deployment tool for deploying the DevOps application among the plurality of application deployment tools. DevOps package providing engine 515 may include a processor and program instructions that, when executed, cause the processor to provide the DevOps application deployment package to a deployment tool plugin associated with the determined application deployment tool among the generated deployment tool plugins. Deployment operation execution engine 516 may include a processor and program instructions that, when executed, cause the processor to execute, by the deployment tool plugin, a deployment operation associated with the received deployment operation instructions based on deployment properties included in the DevOps application deployment package to deploy the application in a DevOps lifecycle stage using the determined application deployment tool.

The foregoing disclosure describes a number of example implementations for automated DevOps application deployment. The disclosed examples may include systems, devices, computer-readable storage media, and methods for performing automated DevOps application deployment. For purposes of explanation, certain examples are described with reference to the components illustrated in FIGS. 1-5. The functionality of the illustrated components may overlap, however, and may be present in a fewer or greater number of elements and components.

Further, all or part of the functionality of illustrated elements may co-exist or be distributed among several geographically dispersed locations. Moreover, the disclosed examples may be implemented in various environments and are not limited to the illustrated examples. Further, the sequence of operations described in connection with FIG. 3 is an example and is not intended to be limiting. Additional or fewer operations or combinations of operations may be used or may vary without departing from the scope of the disclosed examples. Furthermore, implementations consistent with the disclosed examples need not perform the sequence of operations in any particular order. Thus, the present disclosure merely sets forth possible examples of implementations, and many variations and modifications may be made to the described examples. All such modifications and variations are intended to be included within the scope of this disclosure and protected by the following claims.

1. A method for automated development operations (DevOps) application deployment, the method performed by at least one processor and comprising:
generating a DevOps application deployment package for a DevOps application based on a DevOps application model for the DevOps application;
determining, based on the DevOps application deployment package, an application deployment tool for deploying the DevOps application;
providing the DevOps application deployment package to a deployment tool plugin associated with the determined application deployment tool; and
executing, by the deployment tool plugin, a deployment operation based on deployment properties included in the DevOps application deployment package to deploy the DevOps application using the determined application deployment tool.

2. The method of claim 1, wherein determining the application deployment tool for deploying the DevOps application includes determining the application deployment tool among a plurality of application deployment tools.

3. The method of claim 2, comprising:
generating a plurality of deployment tool plugins for the plurality of application deployment tools.

4. The method of claim 1, wherein the deployment properties include at least one of an identification of a web component file for the DevOps application, a location of the web component file, and a port number on which the web component listens.

5. The method of claim 1, wherein the deployment properties include at least one of an identification of a database component file for the DevOps application, a location of the database component file, and a username and password for the database component.

6. The method of claim 1, wherein determining the application deployment tool for deploying the DevOps application includes determining the application deployment tool based on complexity of the DevOps application.

7. The method of claim 6, wherein the complexity of the DevOps application is based on a number of application components to be deployed for the DevOps application and a number of servers on which the application components are to be deployed.

8. The method of claim 1, wherein the deployment operation includes at least one of deploying the DevOps application, undeploying the DevOps application, and redeploying the DevOps application.

9. The method of claim 1, comprising:
deploying the DevOps application using the determined application deployment tool in a DevOps lifecycle stage.

10. The method of claim 9, wherein the DevOps lifecycle stage includes at least one of development, testing, staging, and production.

11. A non-transitory machine-readable storage medium storing instructions that, when executed by a processor, cause the processor to:
generate a development operations (DevOps) application deployment package for a DevOps application based on a DevOps application model for deploying the DevOps application;
determine, based on the DevOps application deployment package, an application deployment tool for deploying the DevOps application among a plurality of application deployment tools;
provide the DevOps application deployment package to a deployment tool plugin associated with the determined application deployment tool; and
execute, by the deployment tool plugin, a deployment operation based on deployment properties included in the DevOps application deployment package to deploy the DevOps application on the determined application deployment tool in a DevOps lifecycle stage, the deployment properties including at least a location of a web component file for the DevOps application.

12. The non-transitory machine-readable storage medium of claim 11, wherein the instructions, when executed by the processor, cause the processor to:
generate a plurality of deployment tool plugins, wherein each application deployment tool of the plurality of application deployment tools is associated with a corresponding deployment tool plugin of the plurality deployment tool plugins.

13. The non-transitory machine-readable storage medium of claim 11, wherein the instructions, when executed by the processor, cause the processor to:
determine the application deployment tool based on complexity of the DevOps application.

14. The non-transitory machine-readable storage medium of claim 11, wherein the deployment properties include at least one of a log file location for the DevOps application, user/developer privileges for the DevOps lifecycle stage, and acceptance criteria for the DevOps application in the DevOps lifecycle stage.

15. The non-transitory machine-readable storage medium of claim 11, wherein the deployment properties include at least one of an address of a server on which a web component of the DevOps application is to be deployed and an address of a server on which a database component of the DevOps application is to be deployed.

16. A system, comprising:
a development operations (DevOps) application manager to:
generate a plurality of deployment tool plugins for a plurality of application deployment tools;
receive deployment operation instructions for deploying a DevOps application;
generate a DevOps application deployment package for the DevOps application based on a DevOps application model for deploying the DevOps application;
determine, based on the DevOps application deployment package, an application deployment tool for deploying the DevOps application among the plurality of application deployment tools;
provide the DevOps application deployment package to a deployment tool plugin associated with the determined application deployment tool among the generated deployment tool plugins; and
execute, by the deployment tool plugin, a deployment operation associated with the received deployment operation instructions based on deployment properties included in the DevOps application deployment package to deploy the application in a DevOps lifecycle stage using the determined application deployment tool.

17. The system of claim 16, wherein the DevOps lifecycle stage includes at least one of development, testing, staging, and production.

18. The system of claim 16, wherein the deployment operation includes redeploying the application.

19. The system of claim 16, wherein the DevOps application manager is to determine an application deployment tool based on complexity of the DevOps application.

20. The system of claim 16, wherein the deployment properties include an identification of an approver for the DevOps lifecycle stage and acceptance criteria for the DevOps application in the DevOps lifecycle stage.
